(19) United States
(12) Patent Application Publication
(10) Pub. No.: US 2008/0221944 A1
(43) Pub. Date: Sep. 11, 2008

(54) System and Method for Risk Assessment and Presentment

(76) Inventors: Martin Kelly, New South Wales (AU); Kam Lun Leung, New South Wales (AU)

Correspondence Address: FOLEY & LARDNER LLP, 150 EAST GILMAN STREET, P.O. BOX 1497, MADISON, WI, 53701-1497, US

(21) Appl. No.: 11/915,515

(22) PCT Filed: May 26, 2006
(86) PCT No.: PCT/AU2006/000706

§ 371 Date: Nov. 26, 2007

(30) Foreign Application Priority Data
May 27, 2005 (AU) 2005902734

(51) Int. Cl. G06F 9/44

(52) U.S. Cl. 705/7

(57) ABSTRACT

The method and system enable risk assessment and presentment. The assessment includes estimation of a loss probability distribution of possible losses arising from the failure of business processes. The loss probability distributions of processes can be aggregated according to respective attribute hierarchies. The risk implications of changes within an organization can be assessed due to the linking of process change and operational risk. Control effectiveness, process value at risk, and a comparison of self-assessment against independent assessment can also be measured. The presentment includes an integrated, hierarchical process view of business operations and associated operational and compliance risks and controls, including the relationship between summary level process maps and the underlying detailed level process maps. The hierarchy contains risk and control attributes associated with any particular process. Process attributes in the hierarchy link bottom level processes to the individual business line, department, product, customer segment, or any other aspects of a business operation.

### CROSS REFERENCE TO RELATED APPLICATIONS

The present application claims priority to Australian Patent Application No. 2005902734 filed on May 27, 2005, and entitled “Methods, Devices And A Computer Program For Creating Information For Use In Facilitating A Risk Assessment,” which is incorporated herein by reference in its entirety.

### BACKGROUND

Risk is inherent in every type of business and commercial activity. Heretofore, systems and methods have been developed to calculate, measure, and manage risk. Such systems and methods have included assigning loss probability distributions to risks associated with processes employed by an organization. These loss probability distributions are intended to better assess and predict risks.

By way of example, U.S. Patent Application Publication No. 2003/0149657 entitled “System and Method for Measuring and Managing Operational Risk,” describes assigning a loss probability distribution to a risk. In Paragraph [0042], it describes a loss event that can be modeled as a frequency or severity distribution. As another example, U.S. Patent Application Publication No. 2003/0236741 entitled “Method for Calculating Loss on Business, Loss Calculating Program, and Loss Calculating Device,” describes business-specific loss probability distributions. It provides an example in Paragraphs [0075]-[0079] of a loss probability distribution in the loan business.

### SUMMARY

Described herein are exemplary embodiments that present an integrated, hierarchical process view of business operations and associated operational and compliance risks and controls. The presentation hierarchy shows the relationship between summary level process maps and the underlying detailed level process maps. The hierarchy contains risk and control attributes associated with any particular process. Process attributes in the hierarchy link bottom level processes to the individual business line, department, product, customer segment, or any other aspects of a business operation.

The exemplary embodiments enable the estimation of a probability distribution of possible losses arising from the failure of business processes. The loss probability distributions of bottom level processes can be aggregated according to respective attribute hierarchies, providing a more integrated and summary view of operational risk and control effectiveness. The hierarchy allows for the examination of specific processes for their risk and compliance relevance and improvement needs. The risk implications of changes within an organization can be assessed due to the linking of process change and operational risk. Control effectiveness, process value at risk, and a comparison of self-assessment against independent assessment can also be measured.

Currently, it is contemplated that the exemplary embodiments can be implemented using a computer program product that receives multiple parameters, can cross correlate these parameters, and present parameters within a framework having attributes corresponding to an organization.

The methodology described herein is applicable to all industry sectors but it is worth noting one particular application within the financial services industry. In the financial services industry, the Basel II operational risk compliance guidelines require various levels of operational risk measurement sophistication depending on the size and complexity of the financial services operations. The most sophisticated guidelines are referred to as the advanced measurement approach (AMA). The particular bottom up approach of the exemplary embodiments is likely to inform and interact with AMA operational risk quantification methods to provide additional insight into operational risk behavior.

The exemplary embodiments can use the Basel II definition of operational risk, which states that “Operational risk is defined as the risk of loss resulting from inadequate or failed internal processes, people and systems or from external events.” Alternatively, this definition could be changed to exclude losses arising from external events so that only those risk events arising from within the organisation are considered.

Another area where the exemplary embodiments can provide input and complement AMA methods is its capacity to isolate the contribution of regulatory compliance risk to operational risk. For example, the Sarbanes Oxley Act of 2002 (SOX), is effectively a prescription for a set of controls that manages a category of operational risk. The operational risk that SOX seeks to manage is the risk of misrepresenting the underlying assets and liabilities of the organization in the financial reports. The exemplary embodiments can provide a detailed insight into the process, risk and control issues associated with compliance risk in general and therefore enable organizations to manage it more effectively.

Another application of the exemplary embodiments is information technology (IT) infrastructure integration, process standardization, centralized controls, event management and other operational risk management benefits. There is a large risk exposure in IT infrastructure support business processes and the failure of these systems. One such risk is the management of numerous disparate IT systems. The lack of a centralized data base or mechanism to co-ordinate their management is costly, complex and represents considerable operational risk to the business. The exemplary embodiments described herein enable the measurement of operational risk exposure, which can be used to justify the introduction of solutions based on cost and operational risk behaviour.

### BRIEF DESCRIPTION OF DRAWINGS

FIG. 1 is a general diagram of a risk assessment and presentment system in accordance with an exemplary embodiment.

FIG. 2 is a hierarchy presentation of process levels generated by a software application in the exemplary system of FIG. 1.

FIG. 3 is a flow diagram depicting operations performed in the exemplary system of FIG. 1.

FIG. 4 is a flow diagram depicting operations performed to determine probability of an event and an amount of event balance based on different frequency levels and severity intervals in the exemplary system of FIG. 1.

FIG. 5 is a tree diagram depicting different possible event conditions.

FIG. 6 is a tree diagram depicting different possible event conditions where the worst event is one of a yearly event.

FIG. 7 is a flow diagram of operations performed in an inter-process aggregation technique used in the system of FIG. 1.

FIG. 8 is a flow diagram depicting operations performed in a likelihood distribution method.

FIG. 9 is an organizational schematic depicting an exemplary embodiment implemented into an organizational setting.

FIG. 10 is a cross function process map for a credit default swap process

FIG. 11 is a parent child process map hierarchy for a credit default swap process

FIG. 12 is a parent child process hierarchy for a credit default swap process showing a top to bottom orientation.

FIG. 13 is a parent child process hierarchy for a credit default swap process showing a left to right orientation.

FIG. 14 is a screen display of an interface of a software application with functionality for constructing a parent child process hierarchy.

FIG. 15 is a number different computer interfaces containing a variety of different hierarchies.

FIG. 16 is a display depicting intra-aggregation of two risks for the selection valuation model process.

FIG. 17 is a display depicting inter-aggregation of risks for all child processes associated with a trade assessment process.

FIG. 18 is a display depicting intra-aggregation of all internal fraud risks associated with credit default swap processes.

### DETAILED DESCRIPTION OF EXEMPLARY EMBODIMENTS

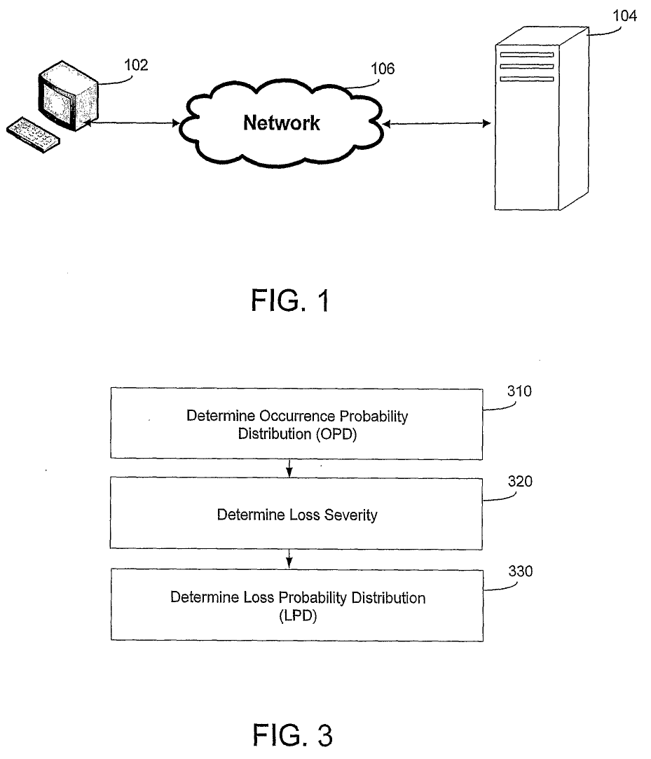

FIG. 1 illustrates an exemplary risk assessment and presentment system 100. The system 100 includes a computer 102 and a database 104. The system 100 also includes a network 106 to which the computer 102 and database 104 are connected. The computer 102 has software including an operating system that provides various system-level operations and provides an environment for executing application software. In this regard, the computer 102 is loaded with a software application that provides information for use in facilitating a risk assessment. The database 104 stores data that is used by the computer 102 in creating the information for use in facilitating the risk assessment.

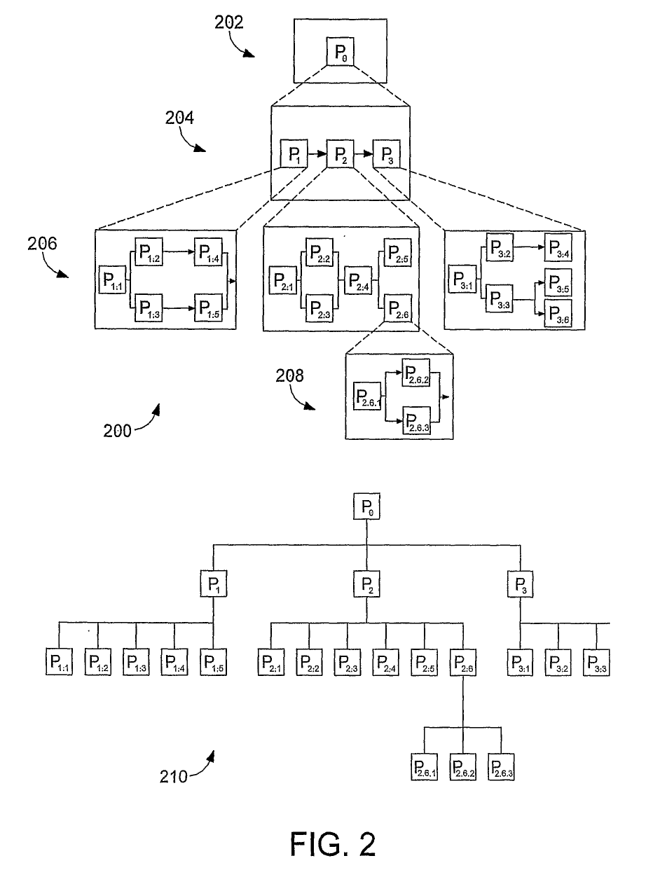

The software application on computer 102 allows a user to identify various processes performed by an organization. For instance, the user could identify that the organization performs a credit check process on all new clients. The software application allows the user to arrange the various identified processes into a tree-like structure or hierarchy 200, which is illustrated in FIG. 2.

Each of the nodes in the hierarchy 200 represents the various processes identified by the user. The hierarchy 200 illustrates the relationship (child/parent) between the various processes performed by the organization. It is noted that the software application can store the identified processes according to the hierarchy 200. The software application is such that it provides a graphical user interface (GUI) that enables a user to identify the processes and arrange them in to the hierarchy 200.

According to an exemplary embodiment, the user constructs the hierarchy 200 utilizing a standard hierarchy from a library. Alternatively, a hierarchy creation tool can be used, such as the Corporate Modeler computer software available from Casewise Systems and described on the Internet at www.casewise.com.

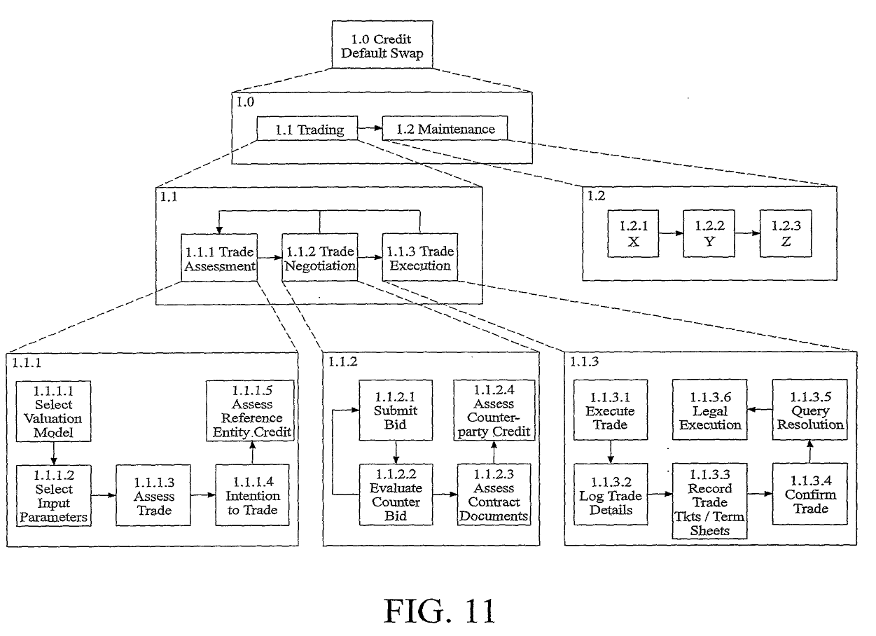

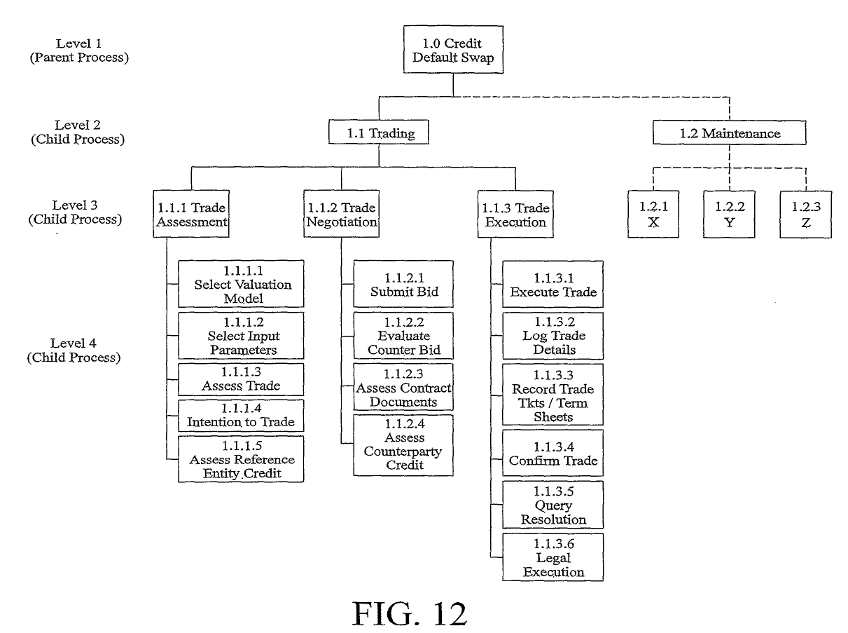

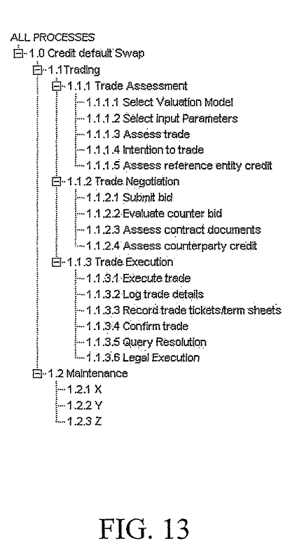

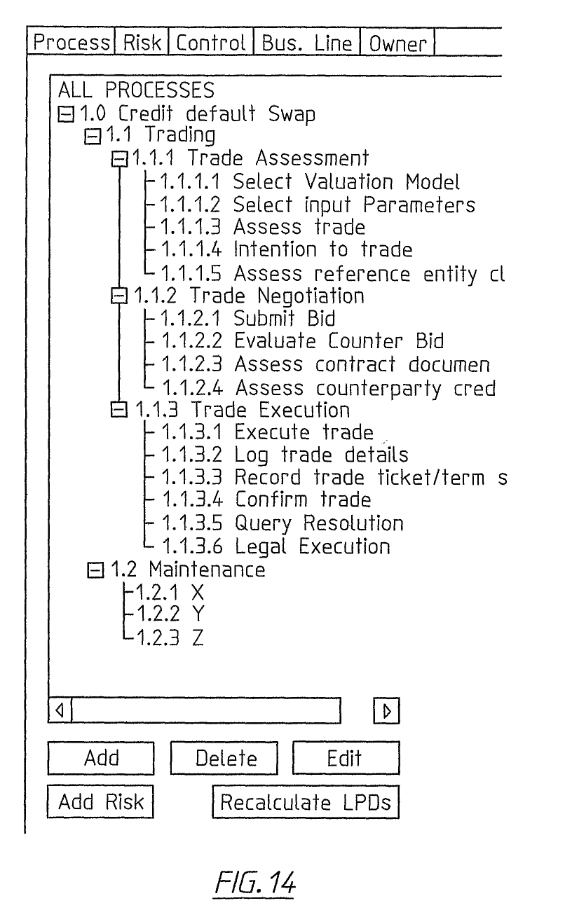

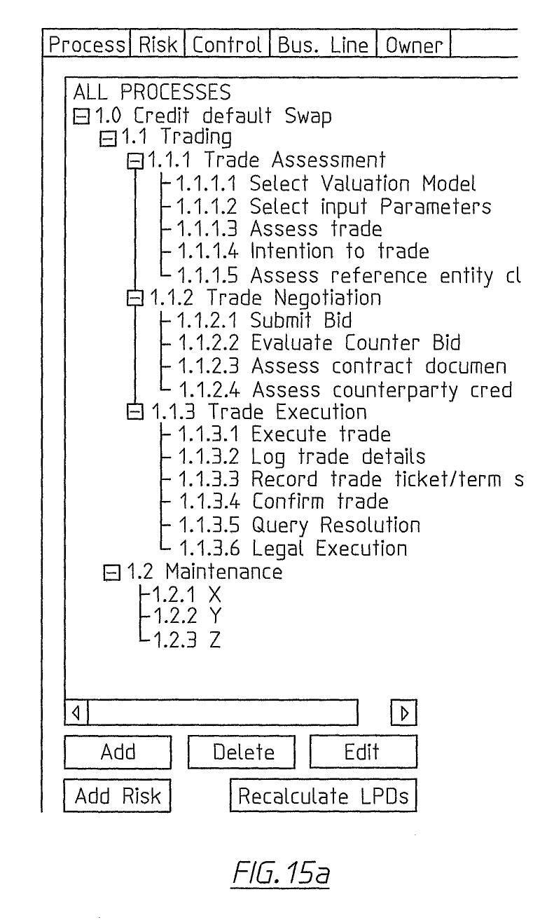

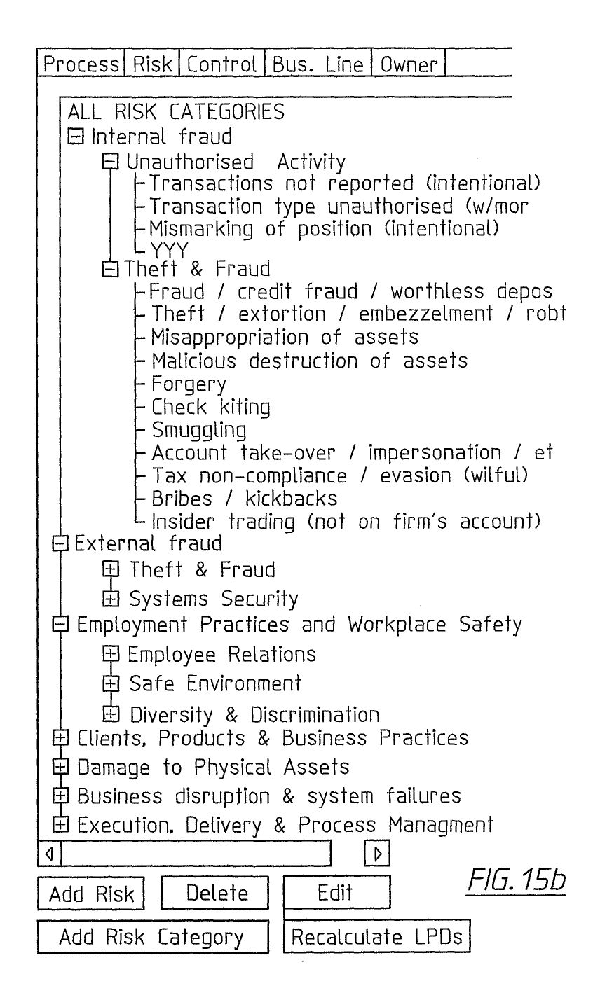

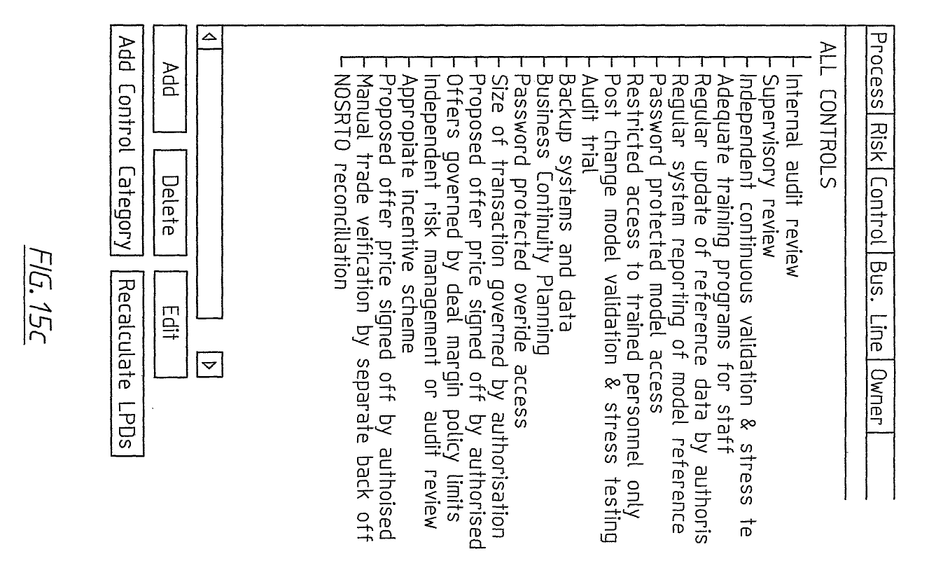

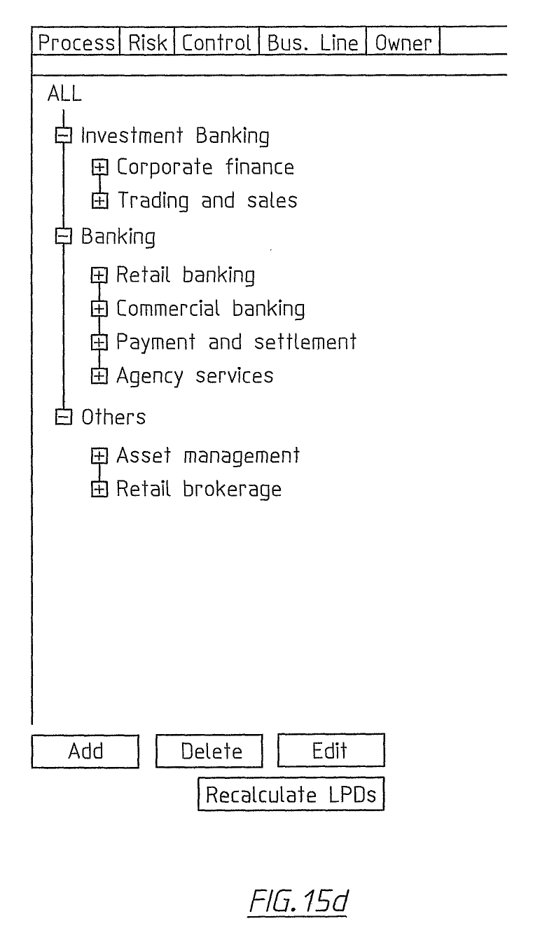

There are numerous ways to represent a process in graphical form. For example, a credit default swap process which typically occurs in a financial service institution could be documented as a: cross functional process map (see FIG. 11); a parent child process map hierarchy (see FIG. 12); a parent child process hierarchy with a top to bottom orientation (see FIG. 13); a parent child process hierarchy with a left to right orientation (see FIG. 14). All of these representations and numerous other possible process documentation conventions can be used to convey important process information for various management purposes, such as, documentation, resource allocation, control, performance measurement and so on. The choice of representation is dependant on management's specific requirements. The exemplary embodiments are not dependant on one process representation. For example, the credit default swap examples described with reference to FIGS. 12-14 demonstrates how the parent child process relationships could be established. As such, there is flexibility in utilizing third party process mapping software to create the parent child process hierarchy. But if third party software is not available, then the parent child process hierarchy can be established using software with functionality similar to that described with reference to FIGS. 14-18. The construction of the process hierarchy can be achieved through importing process data from other programs or constructed by nominating the various child processes as defined by the business and attaching these to the relevant parent processes, also defined by the business, via the add and delete function.

An advantage of allowing the processes to be arranged into the hierarchy 200 is that it can be used to reflect the decision making structure of the organization. Processes are represented by nodes 202, 204, 206, and 208. For example, nodes 204 represent the “level 1” processes which can be those processes relevant to upper management while nodes 206 represent the “level 2” processes which can be those processes relevant to middle management. Nodes 208 represent the bottom level processes which are identified to a granular level and granted additional attributes such as “process owner/manager,” “business line,” “department/cost center,” “product,” and so on. Further attributes such as “branch,” “sales channel,” etc. can be added to the list so far as they are of interest to management for reporting purpose. The hierarchy 200 allows for “process costs,” “operational risks,” and “control measures” to be attached to bottom level processes. Overall, this “tagging system” facilitates the generation of tailored management reports for any set or combination of process attributes. It should also be noted that any number of process attributes such as those previously described, except for risks and controls, can be attached to parent processes.

In addition to allowing the user to identify the various processes performed by the organization and arrange those processes in to the hierarchy 200, the software application loaded on the personal computer 102 allows the user to identify one or more risks associated with each of the processes identified in the hierarchy 200 and assign to each of those risks several loss probability distributions (which can be either discrete or continuous distributions). In this regard, the risk might be, for example, that a credit check performed on new clients of the organization may in some instances be flawed. As with the hierarchy 200, the graphical user interface (GUI) provided by the software application is arranged to allow the user to specify the risks.

Example loss probability distributions assigned to the risks associated with each process can be identified as LPD[1], LPD[2] and LPD[3]. Additional loss probability distributions may be used in alternative embodiments. LDP[1] represents the probability of a loss occurring as a result of the associated risk without the application of any mechanisms for controlling the risk. In the context of the exemplary embodiments, “without risk control mechanisms” can mean “no controls” or “minimum controls” as defined by management, depending on the circumstances and the preferred treatment of the respective management. Generally, the process owner and an independent appraiser should agree on the LPD[1]. The LPD[1] is a baseline where control effectiveness is measured. LPD[2] represents the probability of a loss occurring as a result of the associated risk when the party responsible for the process applies a technique for controlling the risk. The difference between LPD[2] and LPD[1] in the Expected Loss (EL) or Value-at-Risk (VaR) with x % confidence level pertaining to that risk, is a measure of control effectiveness expressed in $ terms set by the process owner. LPD[3] represents the probability of a loss occurring as a result of the associated risk when an independent party assesses the technique for controlling the risk. The difference between LPD[3] and LPD[1] is the Expected Loss (EL) or Value-at-Risk (VaR) with x % confidence level pertaining to that risk, is a measure of control effectiveness expressed in $ terms set by the independent appraiser.

In order to establish the three loss probability distributions (LPD[1], LPD[2] and LPD[3]), the software application loaded on the personal computer 102 is arranged to perform various operations. FIG. 3 illustrates exemplary operations performed to establish loss probability distributions. Additional, fewer, or different operations may be performed depending on the embodiment. In an operation 310, an occurrence probability distribution or the likelihood of an event is determined. This determination can be made using historical data or, in the absence of such data, using estimations. In an operation 320, a loss severity or the impact of the event is determined. Loss severity can be quantified using a range of loss possibilities. In an operation 330, a loss probability distribution is determined for the predicted event.

In the situations where loss event data is available to estimate loss probability distribution, the following exemplary method can be used. While such data may not be available, the exemplary method provides a framework for a set of related questions which can guide assessors in the frequency and severity estimates of loss events. Such questions would be useful when assessors have limited access to empirical data. Instead, assessors can generate estimates using proxy data, qualitative data (e.g., expert opinion), or any combination of proxy and qualitative data. The estimates can then be supported by justifications established from answers to the questions and recorded for future reference.

Advantageously, the exemplary method requires assessors to scrutinize underlying assumptions. Questions relating to frequency and severity distributions are separately identified, allowing assessors to scrutinize underlying components from the loss probability distribution. Expected loss and other statistical variables can be derived from these components, as well. Conventional methods, such as the Impact-Likelihood method assumes assessors can estimated an expected loss for a risk without analyzing the risk's underlying loss probability distribution and respective frequency and severity distributions.

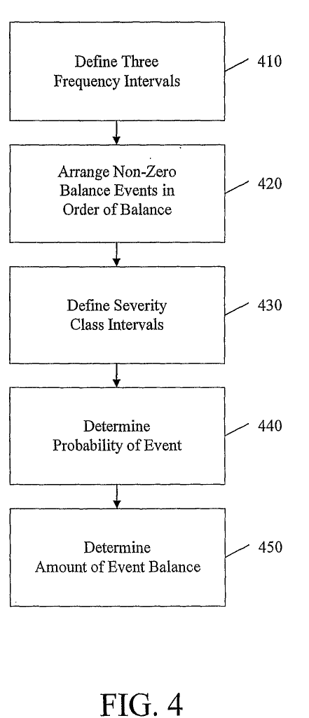

FIG. 4 illustrates operations performed in an exemplary loss probability distribution estimation method. Additional, fewer, or different operations may be performed depending on the embodiment. Further, it may be the case that certain operations can be performed in a different order. For purposes of illustration, the variable Y is the number of years for which historical data is considered. Assuming y years have no risk event, the probability of risk event occurring and not occurring (excluding worst case) are denoted by P₀ and P₁. That is,

P₀=y/Y

and

P₁=1−P₀.

The number of years with at least one occurrence of a non-zero balance event is n=(Y−y). These years are arranged in ascending order of frequency of non-zero balance event. Each balance associates to a value of gain or loss. The respective sequences of year and its corresponding sequence of frequency of non-zero balance event are represented as follows:

Y₁,Y₂, . . . , Yₙ

and

f₍₁₎,f₍₂₎, . . . , f₍ₙ₎.

The variables f₍₁₎ and f₍ₙ₎ are the respective minimum and maximum frequencies of the above non-zero balance event sequence. The frequency range is divided into three equal sub-intervals. The length of the sub-interval is:

l_{f}=(f₍ₙ₎−f₍₁₎)/3.

The variables fₓ and f_{y} are the two points that equally divide the interval [f₍₁₎, f₍ₙ₎] As such,

fₓ=f₍₁₎+l_{f} and f_{y}=f₍₁₎+2l_{f}.

In an operation 410, frequency class intervals are defined as Low Frequency, Medium Frequency and High Frequency. The Low Frequency Class has the range from f₍₁₎ to fₓ. The Medium Frequency Class has a frequency value greater than fₓ and less than or equal to f_{y} while the High Frequency Class has a frequency value greater than f_{y} and less than or equal to f₍ₙ₎. N_{L}, N_{M}, and N_{H} are the numbers in each respective Low, Medium and High Frequency Class. It should be noted that: N_{L}+N_{M}+N_{H}=n.

P_{N}_{_{L}}, P_{N}_{_{M}}, and P_{N}_{_{H}} represent the probability of a low, medium and high level of event occurrence (excluding worst case and no event), respectively. They are defined as:

P_{N}_{_{L}}=N_{L}/n,P_{N}_{_{M}}=N_{M}/n and P_{N}_{_{H}}=N_{H}/n.

The variable p is be the total number of non-zero balance event within those n years. As such,

$$p = {\sum }_{i = 1}^{n} {f}_{( i )} .$$

In an operation 420, non-zero balance events are arranged in descending order of their balance. The sequence of the event balances is: b₍₁₎, b₍₂₎, . . . , b₍ₚ₎. The variables b₍₁₎ and b₍ₚ₎ are the respective maximum and minimum balance of the above sequence of balances. The balance range is divided into three equal sub-intervals. The length of the sub-interval is: l_{b}=(b₍₁₎−b₍ₚ₎)/3. The two points that equally divide the interval [b₍₁₎, b₍ₚ₎] are bₓ and b_{y}. Hence, bₓ=b₍₁₎−l_{b} and b_{y}=b₍₁₎−2l_{b}.

In an operation 430, severity class intervals are defined as Low Severity, Medium Severity and High Severity. The Low Severity Class has a range from b₍₁₎ to bₓ. The Medium Severity Class has a balance value greater than bₓ and less than or equal to b_{y} while the High Severity Class has a balance value greater than b_{y} and less than or equal to b₍ₚ₎. Each b₍ᵢ₎ falls into one of the severity classes and it also associates to a particular year. Depending on the frequency of event occurrence of that year being considered, b₍ᵢ₎ belongs to the corresponding Frequency class. Table 1 shows a three by three Table of Frequency Occurrence Class and Severity of balance incurred. If the number of b₍ᵢ₎ in each cell is counted, each symbol in Table 1 represents the total count of a particular cell. If all the b₍ᵢ₎ 's value in each cell are added, each symbol in Table 2 shows the total balance of a particular cell.

TABLE 1

Severity

| Frequency | Low | Medium | High | Total |
|---|---|---|---|---|
| Low | n_{LL} | n_{LM} | n_{LH} | N_{L} |
| Medium | n_{ML} | n_{MM} | n_{MH} | N_{M} |
| High | n_{HL} | n_{HM} | n_{HH} | N_{H} |

TABLE 2

Severity

| Frequency | Low | Medium | High | Total |
|---|---|---|---|---|
| Low | A_{LL} | A_{LM} | A_{LH} | A_{L} |
| Medium | A_{ML} | A_{MM} | A_{MH} | A_{M} |
| High | A_{HL} | A_{HM} | A_{HH} | A_{H} |

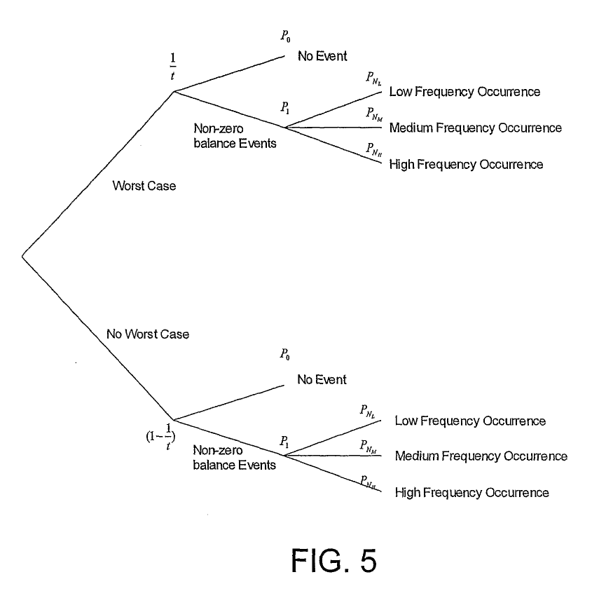

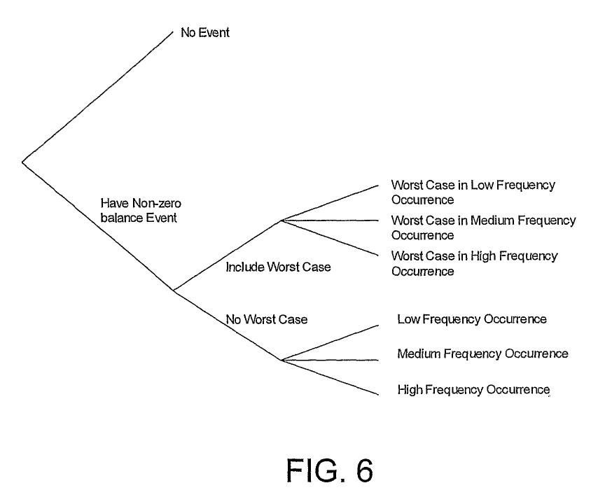

The worst case scenario happens every t years. The worst case of loss amount is denoted as T. It is assumed that the worst case scenario is independent to the yearly event. FIG. 5 shows different possible event conditions. In an operation 440, the probability of an event is determined, in an operation 450, the amount of event balance is determined. The probability of getting a different event condition is shown in Table 3 with the corresponding amount of event balance. FIG. 6 illustrates different event conditions where the worst event is part of a yearly event.

TABLE 3

| | | Amount of Event |
|---|---|---|
| Event | Probability of Event | Balance |
| Worst Case and no event | (1/t) × P₀ | T |
| occurrence | | |
| Worst case, non-zero | (1/t) × P₁ × P_{N}_{L} | T + A_{L} |
| balance events and low | | |
| frequency occurrence | | |
| Worst case, non-zero | (1/t) × P₁ × P_{N}_{M} | T + A_{M} |
| balance events and medium | | |
| frequency occurrence | | |
| Worst case, non-zero | (1/t) × P₁ × P_{N}_{H} | T + A_{H} |
| balance events and high | | |
| frequency occurrence | | |
| No worst case and no event | (1 − 1/t) × P₀ | 0 |
| occurrence | | |
| No worst case, non-zero | (1 − 1/t) × P₁ × P_{N}_{L} | A_{L} |
| balance event and low | | |
| frequency occurrence | | |
| No worst case, non-zero | (1 − 1/t) × P₁ × P_{N}_{M} | A_{M} |
| balance events and medium | | |
| frequency occurrence | | |
| No worst case, non-zero | (1 − 1/t) × P₁ × P_{N}_{H} | A_{H} |
| balance events and high | | |
| frequency occurrence | | |

Once the software application on the computer 102 has calculated the loss probability, the software application can provide information for facilitating a risk assessment. In this regard, the software application is arranged to allow the user to select one or more of the processes represented in the hierarchy 200 (see FIG. 2) via a graphical user interface (GUI).

On determining which of the nodes in the hierarchy 200 have been selected by the user, the software application uses the selection to calculate a resultant loss probability distribution, which represents the information for facilitating a risk assessment. In this regard, the software application is arranged to perform at least two aggregating operations on the loss probability distributions associated with the risks associated with the nodes in the hierarchy 200.

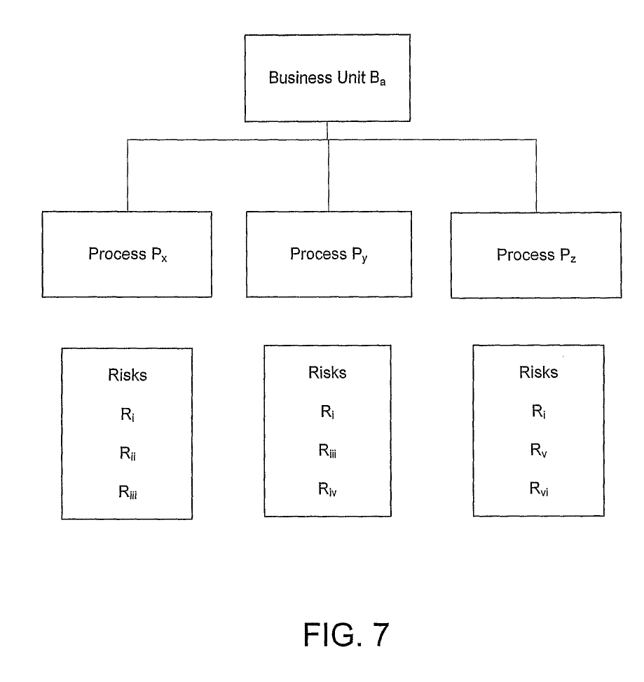

A first of the aggregating operations is an ‘inter-process’ aggregation which involves aggregating all the loss probability distributions that are associated with the child nodes of a particular node (process) in the hierarchy 200. For example, with reference to FIG. 7, the inter-process aggregation involves aggregating the loss probabilities associated with Rᵢ for processes Pₓ, P_{y}, and P_{z}, Rᵢᵢᵢ for processes Pₓ and P_{y}, etc. Thus, the resultant loss probability distribution for business unit Bₐ would be the aggregate of the loss probabilities associated with Rᵢ for Pₓ, P_{y}, and P_{z}, the aggregate of the loss probabilities Rᵢᵢᵢ for Pₓ and P_{y}, etc. Table 4 shows example loss distributions of Rᵢ for Pₓ, P_{y} and P_{z} to illustrate this aggregation methodology.

TABLE 4

| | | |
|---|---|---|
| Pₓ | P_{y} | P_{z} |

| Prob. | $ Loss | Prob. | $ Loss | Prob. | $ Loss |
|---|---|---|---|---|---|
| 0.3 | 10 | 0.9 | 5 | 0.5 | 10 |
| 0.4 | 20 | 0.05 | 10 | 0.5 | 30 |
| 0.3 | 30 | 0.03 | 50 | | |
| | | 0.02 | 100 | | |
| 1 | | 1 | | 1 | |

Table 5 shows the loss distribution of Rᵢ for P_{w} using the figures from Table 4.

TABLE 5

| | |
|---|---|
| Probability of loss | $ Amount loss |

| | | | |
|---|---|---|---|
| 0.135 | = 0.3 × 0.9 × 0.5 | 25 | = 10 + 5 + 10 |
| 0.135 | = 0.3 × 0.9 × 0.5 | 45 | = 10 + 5 + 30 |
| 0.0075 | = 0.3 × 0.05 × 0.5 | 30 | = 10 + 10 + 10 |
| 0.0075 | = 0.3 × 0.05 × 0.5 | 50 | = 10 + 10 + 30 |
| 0.0045 | = 0.3 × 0.03 × 0.5 | 70 | = 10 + 50 + 10 |
| 0.0045 | = 0.3 × 0.03 × 0.5 | 90 | = 10 + 50 + 30 |
| 0.003 | = 0.3 × 0.02 × 0.5 | 120 | = 10 + 100 + 10 |
| 0.003 | = 0.3 × 0.02 × 0.5 | 140 | = 10 + 100 + 30 |
| 0.18 | = 0.4 × 0.9 × 0.5 | 35 | = 20 + 5 + 10 |
| 0.18 | = 0.4 × 0.9 × 0.5 | 55 | = 20 + 5 + 30 |
| 0.01 | = 0.4 × 0.05 × 0.5 | 40 | = 20 + 10 + 10 |
| 0.01 | = 0.4 × 0.05 × 0.5 | 60 | = 20 + 10 + 30 |
| 0.006 | = 0.4 × 0.03 × 0.5 | 80 | = 20 + 50 + 10 |
| 0.006 | = 0.4 × 0.03 × 0.5 | 100 | = 20 + 50 + 30 |
| 0.004 | = 0.4 × 0.02 × 0.5 | 130 | = 20 + 100 + 10 |
| 0.004 | = 0.4 × 0.02 × 0.5 | 150 | = 20 + 100 + 30 |
| 0.135 | = 0.3 × 0.9 × 0.5 | 45 | = 30 + 5 + 10 |
| 0.135 | = 0.3 × 0.9 × 0.5 | 65 | = 30 + 5 + 30 |
| 0.0075 | = 0.3 × 0.05 × 0.5 | 50 | = 30 + 10 + 10 |
| 0.0075 | = 0.3 × 0.05 × 0.5 | 70 | = 30 + 10 + 30 |
| 0.0045 | = 0.3 × 0.03 × 0.5 | 90 | = 30 + 50 + 10 |
| 0.0045 | = 0.3 × 0.03 × 0.5 | 110 | = 30 + 50 + 30 |
| 0.003 | = 0.3 × 0.02 × 0.5 | 140 | = 30 + 100 + 10 |
| 0.003 | = 0.3 × 0.02 × 0.5 | 160 | = 30 + 100 + 30 |
| Total = 1 | | | |

After arranging the loss amount into ascending order and adding together the probabilities for the same loss amounts (i.e., 45, 50, 70, 90, and 140), the loss distribution of Rᵢ for P_{w} becomes as shown in Table 6.

TABLE 6

| $ Loss amt. | Prob. | Cumulative Prob. |
|---|---|---|
| 25 | 0.135 | 0.135 |
| 30 | 0.0075 | 0.1425 |
| 35 | 0.18 | 0.3225 |
| 40 | 0.01 | 0.3325 |
| 45 | 0.27 | 0.6025 |
| 50 | 0.015 | 0.6175 |
| 55 | 0.18 | 0.7975 |
| 60 | 0.01 | 0.8075 |
| 65 | 0.135 | 0.9425 |
| 70 | 0.012 | 0.9545 |
| 80 | 0.006 | 0.9605 |
| 90 | 0.009 | 0.9695 |
| 100 | 0.006 | 0.9755 |
| 110 | 0.0045 | 0.98 |
| 120 | 0.003 | 0.983 |
| 130 | 0.004 | 0.987 |
| 140 | 0.006 | 0.993 |
| 150 | 0.004 | 0.997 |
| 160 | 0.003 | 1 |
| | 1 | |

A second of the aggregating operations is an ‘intra-process’ aggregation, which involves aggregating loss probability distributions of various risks associated with a process. For example, again referring to FIG. 7, the intra-process aggregation involves aggregating the loss probabilities associated with Rᵢ, Rᵢᵢ, and Rᵢᵢᵢ. Thus, the resultant loss probability distribution for process P would be the aggregate of the loss probability distributions for Rᵢ, Rᵢᵢ, and Rᵢᵢᵢ. When aggregating loss probability distributions, the software application is arranged to take into account the effect that different probability distributions can have on each other. This is achieved by processing a correlation coefficient, which the computer 102 can obtain from the database 104 via the communication network 106. Once the resultant loss probability distribution has been calculated, the software application displays the resultant distribution on the monitor of the computer 102, or prints on paper, so that a risk assessor can use it when considering the impact of risk.

For a set of distributions where the total number of possible combinations becomes unmanageable to compute, a number of alternate strategies can be used to estimate an aggregate distribution for expected loss. One strategy reduces the number of outcomes in each of the individual low level distributions prior to starting the aggregation process. For example, where a particular low level distribution contains five possible outcomes, then the number can be reduced down to a lower number of outcomes using one of the methods described below. In this way, whereas we may have a set of ten low level distributions to be aggregated, with each distribution starting out with five possible outcomes, we can reduce the number of computations down from n=5̂10=9.765 million to n=3̂10=59,049 by aggregating within each of the low level distributions prior to starting the process of aggregating the entire set of 10 distributions.

When the distribution of a parent process is constructed, the number of possible loss values increases. This parent process can be the child process of another parent process. This parent and children relationship can be propagated into many levels. The number of calculations involved to evaluate the loss distribution from one level to another increases drastically. Therefore, it is desirable to restrict the number of loss values for the distribution at each level so that the time to complete all the calculation for all levels within a system is within a realistic timeframe. A method of probability aggregation together with their expected loss values is here described.

P(W=wᵢ)=pᵢ is defined as the probability from a loss distribution, W, of a parent process (P_{w}) where i 1, 2, . . . , n. Each pᵢ corresponds to a loss value of wᵢ. The product of wᵢ and pᵢ is the expected loss when W=wᵢ. The largest possible in is used such that:

$${\sum }_{i = 1}^{m} {p}_{i} \leq 0.5 .$$

Three equal intervals are obtained by sub-dividing the interval [wₗ, wₘ]. Similarly, divide the interval [wₘ, wₙ] is divided into 3 equal sub-intervals. The variables r and s are the respective length of the first three sub-intervals and the remaining three intervals. Hence,

r=(wₘ−wₗ)/3

and

S=(wₙ−wₙ)/3.

Where wₐ and w_{b} are the two points that equally divide the interval [wₗ, wₘ]. Also, w_{c} and w_{d} are the two points that equally divide the interval [wₘ, wₙ]. Hence,

wₐ=wₗ+r,

w_{b}=wₗ+2r,

w_{c}=wₘ+s

and

w_{d}=wₘ+2s.

A set of new probabilities are calculated by considering different range of loss values. Each new probability (P(U=uⱼ)) is the sum of probabilities from the distribution W that their loss values fall into a particular loss range being considered. The sum of their corresponding expected loss values (lᵢ) becomes the expected loss of this new probability (Lⱼ). The new loss probability distribution and its expected loss values are shown in Table 7.

TABLE 7

| | Expected Loss | |
|---|---|---|
| Probability Distribution of U | (Lⱼ) | Loss Value (uⱼ) |
| P(U = u₁) = P(w₁ ≦ W ≦ wₐ) | L₁ | u₁ = L₁/P(U = u₁) |
| P(U = u₂) = P(wₐ < W ≦ w_{b}) | L₂ | u₂ = L₂/P(U = u₂) |
| P(U = u₃) = P(w_{b} < W ≦ wₘ) | L₃ | u₃ = L₃/P(U = u₃) |
| P(U = u₄) = P(wₘ < W ≦ w_{c}) | L₄ | u₄ = L₄/P(U = u₄) |
| P(U = u₅) = P(w_{c} < W ≦ w_{d}) | L₅ | u₅ = L₅/P(U = u₅) |
| P(U = u₆) = P(w_{d} < W ≦ wₙ) | L₆ | u₆ = L₆/P(U = u₆) |

If a loss distribution is symmetric, wₘ can be the mid-point between wₗ and wₙ. However, assuming the loss distribution is positively skewed, as is typically the case, the selection of wₘ is based on the cumulated probability closed to 0.5. Totally, six intervals are defined. If the number of interval is still too high, it can be reduced further, for example to four, by defining a mid-point between wₗ and wₘ and another mid-point between wₘ and wₙ.

The number of values in a distribution can also be reduced by minimizing the sum of squared error and/or assigning a functional form. The form is done by computing the mean (M0) and standard deviation (S0) of the initial distribution, defining a new distribution with fewer possible outcomes, systematically selecting values of these outcomes U and computing the mean (Sn) and standard deviation (Sn) of each new distribution for each new combination of U. Then, the sum of squared errors is computed as sum[(Mn−M0)̂2+(Sn−S0)̂2], the vector of values U=(u1,u2, . . . , un) is identified that minimize the sum of squared errors defined above, and the initial distribution is replaced with this vector U and the associated cumulative probabilities. The latter technique (assigning a functional form) involves identifying the general functional form and the specific values of any corresponding parameters that most closely approximates the original discrete distribution. This can be done for a particular discrete probability distribution by first computing the cumulative probability function of the distribution. This cumulative distribution function is compared with the relevant corresponding cumulative distribution functions of a range of continuous distributions to identify the most appropriate approximation. The most appropriate continuous distribution is selected to serve as an approximation to the original discrete probability distribution. The selection can be based upon either (1) correlation coefficient or (2) minimizing the squared error of estimation, both of these measures being computed on the basis of the cumulative distribution functions of the original and the approximate distributions.

A second strategy for reducing the number of values in the distribution invokes the Central Limit Theorem (CLT) to facilitate the summation of each lower level distribution into an overall aggregate distribution. The CLT states that the mean and variance of a sum of random variants tends toward normality, with an aggregate mean equal to the sum of the means and an aggregate variance equal to the sum of the variances. This strategy can be applied to aggregate distributions where the range of loss severities are similar, such that the range of possible outcomes in any given distribution does not dominate the range of possible outcomes in all other distributions and where each distribution to be summed has finite mean and variance.

Where there exists a subset of low level distributions to be aggregated, each member of the subset having a range of possible outcomes that are within the same order of magnitude, then the CLT can be invoked to estimate the moments of the aggregated distribution. The shape and confidence intervals for an aggregated distribution can then be computed using the aggregate mean and variance together with a table of percentiles for the appropriate “attractor” distribution. In the most general case this will be the standard normal distribution. Where there exists more than one subset within a given set, then the CLT method can be applied separately to each subset to generate an aggregate distribution for each subset. Then the method of aggregation described in Strategy 1 above can be used to aggregate these distributions.

Yet another strategy for reducing the number of values in a distribution involves any combination of strategies 1 and 2 above, selected in part or whole and in sequence so as to produce the best possible aggregation taking into account the number and characteristics of distributions to be aggregated.

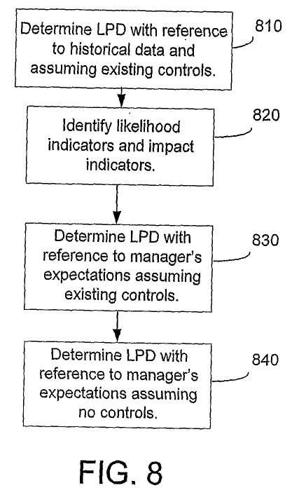

FIG. 8 illustrates operations performed in an exemplary likelihood distribution method. Additional, fewer, or different operations may be performed depending on the embodiment. Further, it may be the case that certain operations can be performed in a different order. In an operation 810, a likelihood probability distribution (LPD) is determined with reference to historical data, assuming existing controls. The LPD can be determined in accordance with operations such as those described with reference to FIGS. 3-4. In an operation 820, likelihood indicators and impact indicators are identified. The LPD with reference to manager's expectations is determined assuming existing controls in an operation 830. Managers are requested to look ahead into the next 12 months (for example) to consider whether the values of the “likelihood indicators” and “impact indicators” will change. Any changes and comments are recorded. An example of this type of analysis is presented for a reconciliation process, see Table 8 and 9. On the basis of this new information the operations in FIGS. 3-4 are revisited so that a new LPD is determined.

TABLE 8

| Likelihood | | | | |
|---|---|---|---|---|
| Indicators | | Current | Expected | |
| (LI_{N}) | Definition | Value | Value | Comments |
| LI₁ | % of staff in reconciliation | 10% | 17% | New staff to be recruited |
| | team with <3 months training | | | |
| LI₂ | number of items processed | 1 mil | 1.5 mil | Expansion of business |
| LI₃ | average outstanding duration | 3 days | 3 days | NA |
| | of unreconciled items | | | |
| LI₄ | amount of staff resources | 10 FTE's | 12 FTE's | Plan to employ new staff |
| | assigned to perform | | | |
| | reconciliation task | | | |

TABLE 9

| Impact | | | | |
|---|---|---|---|---|
| Indicators | | Current | Expected | |
| (II_{N}) | Definition | Value | Value | Comments |
| II₁ | average $ amount of items | 10000 | 10000 | NA |
| | processed | | | |
| II₂ | additional handling fees, | 5% | 5% | NA |
| | interest or charges on | | | |
| | unreconciled items | | | |

In an operation 840, managers are asked to consider whether the “likelihood indicators” and “impact indicators” are likely to change if the controls of the process are relaxed one by one. This approach can be illustrated using the reconciliation process example similar to operation 830. In the example below (see Tables 10 and 11), the controls are relaxed and the managers expected cumulative changes recorded. The managers are then in a better position to revisit operations described with reference to FIGS. 3-4 with a list of event loss drivers that will direct their responses to the relevant likelihood and impact questions. Hence, the LPD assuming without controls can be determined.

TABLE 10

| Likelihood | | | | | | |
|---|---|---|---|---|---|---|
| Indicators | | Expected | Relax | Relax | Relax | Cumulative |
| (LI_{N}) | Definition | Value | C₁ | C₁, C₂ | C₁, C₂, C₃ | changes |
| LI₁ | % of staff in | 17% | | | | 17% |
| | reconciliation team | | | | | |
| | with <3 months training | | | | | |
| LI₂ | number of items | 1.5 mil | | | | 1.5 mil |
| | processed | | | | | |
| LI₃ | average outstanding | 3 days | 4 days | 5 days | 7 days | 7 days |
| | duration of unreconciled | | | | | |
| | items | | | | | |
| LI₄ | amount of staff | 12 FTE's | | | | 12 |
| | resources assigned to | | | | | |
| | perform reconciliation | | | | | |
| | task | | | | | |

TABLE 11

| Impact | | | | | | |
|---|---|---|---|---|---|---|
| Indicators | | Expected | Relax | Relax | Relax | Cumulative |
| (II_{N}) | Definition | Value | C₁ | C₁, C₂ | C₁, C₂, C₃ | changes |
| II₁ | average $ amount of | 10000 | | | | 10000 |
| | items processed | | | | | |
| II₂ | additional handling fees, | 5% | 6% | 7% | 8% | 8% |
| | interest or charges on | | | | | |
| | unreconciled items | | | | | |

The operations may reveal that some controls do not impact on any of the likelihood impact indicators. This result may indicate one or more of the following situations: (i) the controls are “detective” rather than “preventative,” (ii) some indicators are not properly identified, or (iii) the controls are redundant.

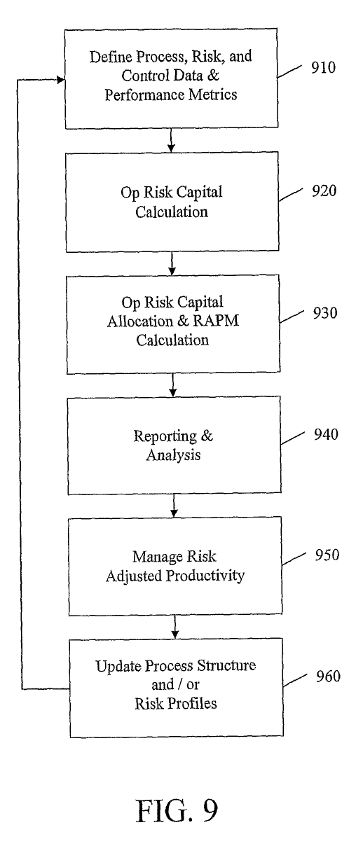

FIG. 9 illustrates an exemplary process for integrating operational and compliance risk into risk adjusted performance metrics. Additional, fewer, or different operations may be performed depending on the embodiment. Further, it may be the case that certain operations can be performed in a different order. In an operation 910, data and performance metrics are defined. Such metrics can be different for different groups of an organization. For example, business divisions or departments, line management, process owners, auditors, board members, compliance officers, and the such can define different data and performance metrics. Process owners can gather data, identify key risk indicators, assess risk and control, and generate process maps. Line management can review the process maps, review risk and control assessment, and identify process metrics. Other functions can be carried out by different entities within the organization, as appropriate.

In an operation 920, an operational risk calculation is performed. This operational risk calculation can include the risk calculations described with reference to the Figures herein. The board of directors can set the operational and compliance risk appetite and confidence levels. Auditors can review the board's decisions and directions. In an operation 930, there is an allocation of operational risk capital and a calculation of risk adjusted performance metrics (RAPM). For example, operational risk capital can be allocated to relevant owners. Incentives for line managers and process owners can be set. Metrics can be calibrated and adjustments made based on results from the risk calculations.

In an operation 940, a variety of different reports are generated and analysis performed at all levels of the organization. In an operation 950, risk adjusted productivity is managed. For example, process owners can collect risk data and deploy resources in accordance with operational risk metrics and risk adjusted performance metrics objectives. Line management can deploy resources in accordance with these objectives and divisions or departments can align resources according to these objectives. In an operation 960, process structures and/or risk profiles are updated and the evaluation process continues.

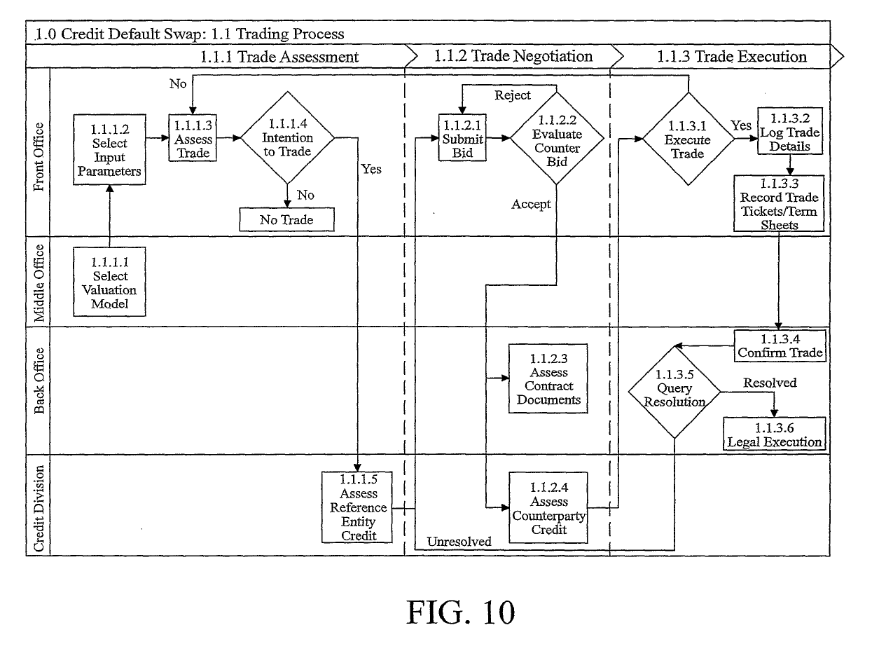

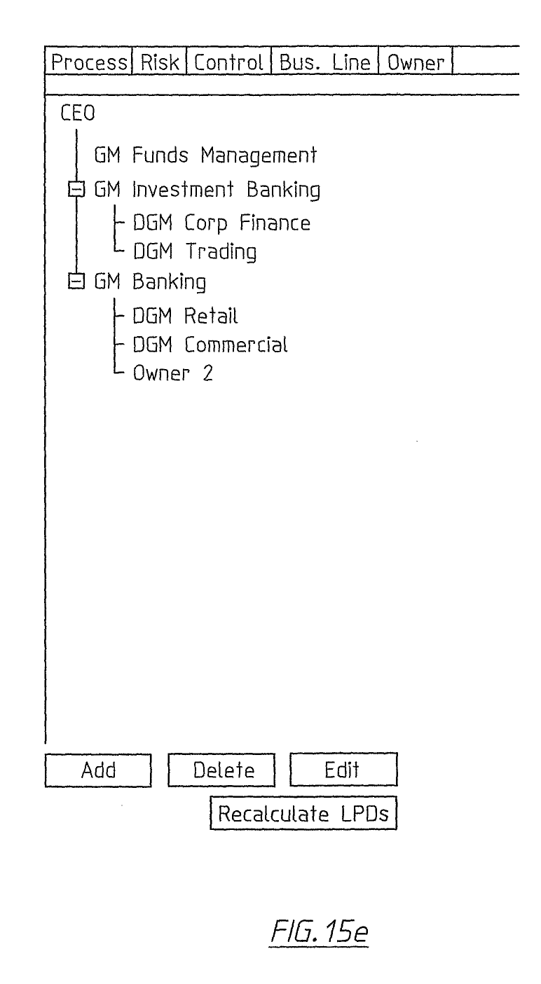

FIG. 10 illustrates a cross-function process map for a credit default swap process. The process map graphically illustrates operations behind a credit default swap, including a trade assessment, trade negotiation, and trade execution. FIG. 11 illustrates a parent child process map hierarchy for the credit default swap process. The hierarchy presents the various component parts that make us the credit default swap. FIG. 12 illustrates a top to bottom orientation to the credit default swap process. FIG. 13 illustrates a left-to-right orientation to the credit default swap process. Such a left-to-right orientation can be depicted in a computer user interface, using collapsible and expandable folder and sub-folder structures. An example computer interface having the hierarchy depicting in a left-to-right orientation is shown in FIG. 14. FIG. 15 illustrates a number different computer interfaces containing a variety of different hierarchies.

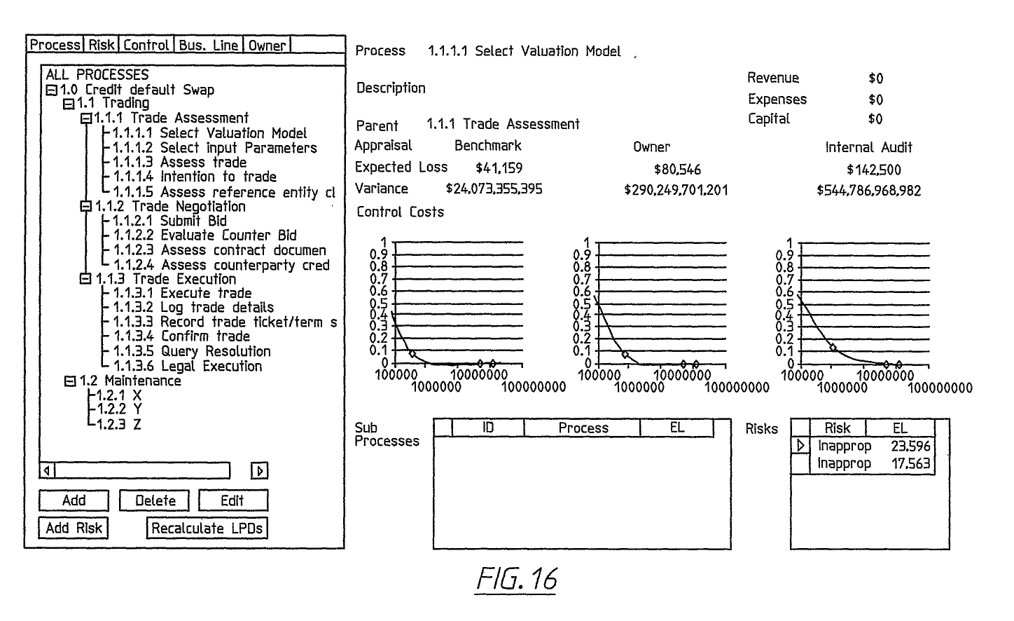

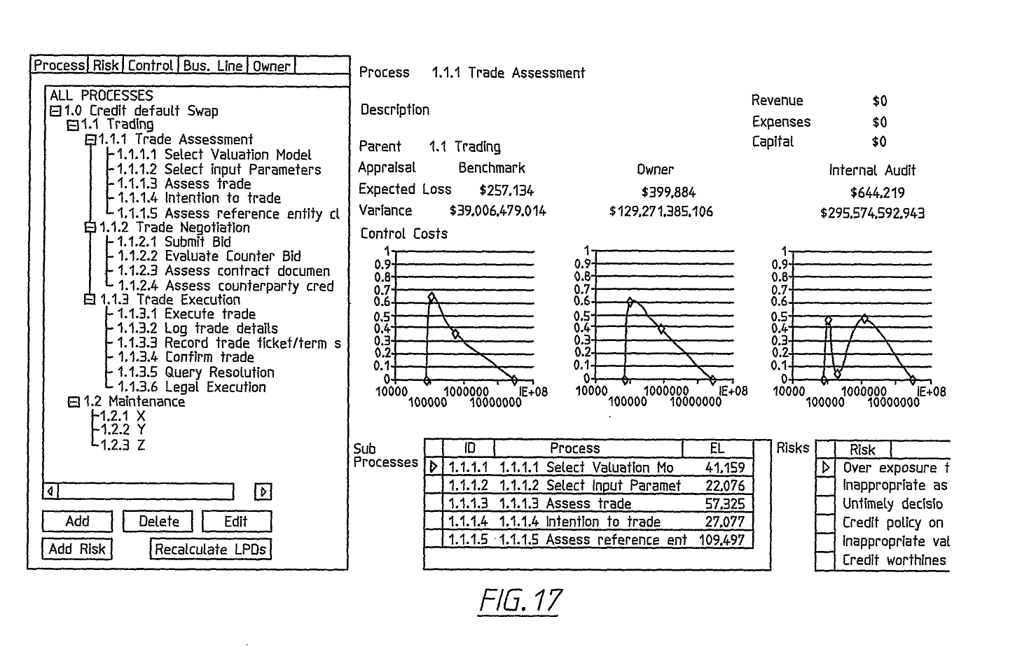

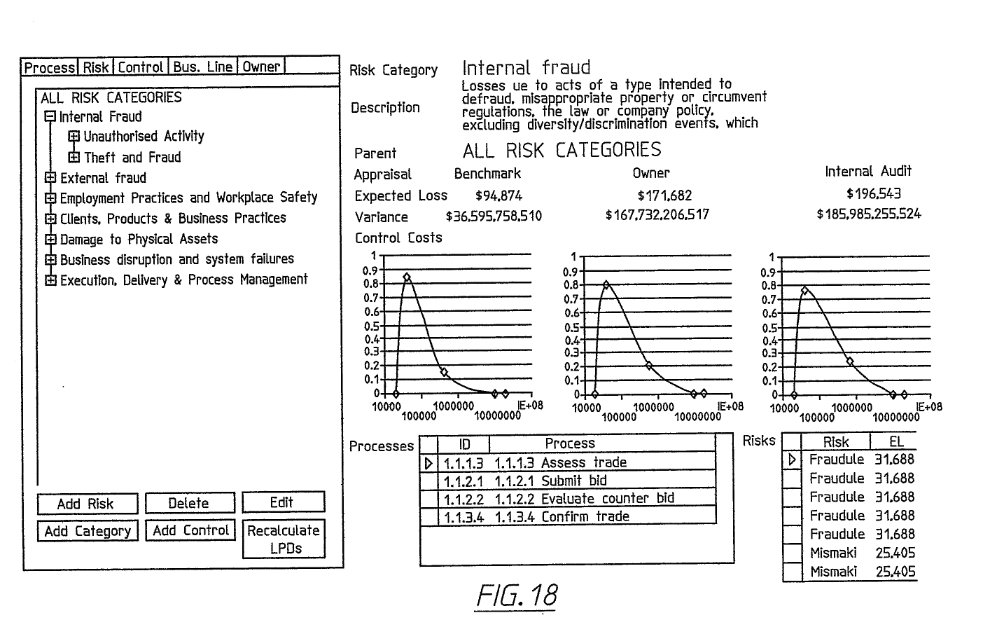

FIG. 16 illustrates a computer interface showing inter-aggregation of two risks for a selection valuation model. FIG. 17 illustrates a computer interface showing intra-aggregation of risks for all child processes associated with a trade assessment process. FIG. 18 illustrates a computer interface showing inter-aggregation of internal fraud risks associated with credit default swap processes.

The methodology described herein with respect to the exemplary embodiments provides a number of advantages. For example, the exemplary methodology attaches operational risk attributes and loss probability distributions (LPDs) to bottom level processes. Operational risks; controls; budget/actual costs; and LPDs due to the individual operational risks are associated with the bottom level processes which also have attributes including but not limited to: owner process ID, parent process ID, process owner/manager, department to which the process belongs, business unit to which the process belongs, and product to which the process is supporting.

Further, the exemplary methodology enables multiple party evaluation/validation for the risk and control details of bottom level processes. Process owners and independent reviewers need to agree on the state and correctness of operational risk and control information prior to constructing the set of LPDs. The exemplary-methodology is designed to support the modeling of multiple LPDs for each operational risk at bottom level processes to enhance the quality of independent reviews. The use of LPDs (LPD[1]: assumed without control (or, as discussed above, with minimum controls defined by management); LPD[2]: assumed with control assessed by process owner; LPD[3]: assumed with control assessed by independent reviewer, . . . etc.) to capture multiple parties' assessment on risk and control effectiveness enhances the process/quality of independent review, making it more standardized, accurate, and transparent across the organization.

The exemplary methodology enables the inter-aggregation of the set of LPDs for individual risks of the bottom level processes along the respective hierarchies of the various attributes (e.g. process/business unit/department/product/ . . . etc.) in order to establish a set of LPDs for every risk at each process/business unit/department/product . . . etc. in their respective hierarchies. The exemplary methodology aggregates sets of LPDs (i.e. LPD[1]: assumed without control (or minimum control); LPD [2]: assumed with control assessed by process owner; LPD [3]: assumed with control assessed by independent reviewer, etc.) for individual operational risks of the bottom level processes to their parent processes up the process hierarchy such that every parent process has a corresponding set of aggregated LPDs for the respective operational risk. This aggregation is also performed according to the respective hierarchy of other attributes (e.g. individual business line, department, product, . . . etc). As far as their effects are updated in the respective LPDs and then aggregated up the respective hierarchies, changes to the risk/control profile at the bottom level processes are automatically reflected to all parent processes, business units, departments, and products.

The exemplary methodology enables the intra-aggregation of the sets of LPDs for all operational risks at each process/business unit/department/product . . . etc. into 1 set of LPDs (i.e. LPD[1], LPD[2], LPD[3]) for every process/business unit/department/product . . . etc. PRIM aggregates sets of LPDs for the various operational risks under a process into one set of LPDs for that particular process. The same is also performed for other attributes, i.e. individual business line, department, product . . . etc. This enables the reporting of ‘Expected Loss’ (EL) and ‘Value at Risk with x % of confidence level’ (VaR) in dollar terms for every process/business unit/department/product . . . etc.

The exemplary methodology can provide reports quantifying the organizations risk capital allocation requirement. Quantitative measures of operational risks such as ‘Expected Loss’ (EL) and ‘Value at Risk with x % confidence level’ (VaR) are expressed in dollar terms, and are readily available with the LPDs for processes, departments, business units, and products. As a result, a basis for operational risk capital allocation is readily available for processes, departments, business units, and products levels using ‘EL’ or ‘VaR’ as an allocation basis.

The exemplary methodology provides a means to identify the component of the organizations risk capital allocation requirement that is attributed to compliance risk. The process, risk and control analysis prescribed by the methodology, which includes the application of LID, enables the aggregation of only those LPDs associated with compliance risks. The exemplary methodology measures control effectiveness based on LPDs and in dollar terms. By comparing LPD ‘assumed with control’ and LPD ‘assumed without control’, the methodology enables the measurement of control effectiveness to be based on LPDs and expressed in dollar terms (e.g. “Expected Loss (EL) is reduced by $n” and “Value-at-Risk with a x % confidence level (VaR) is reduced by $n”) for individual process, business unit, department, product . . . etc. Control effectiveness measurement expressed in dollar terms facilitates the cost-benefit analysis for controls.

The exemplary methodology recognizes the complex operational risk behavior that can arise from an interdependent network of business processes. Network effect refers to the situation where the successful performance of a process (e.g., Process A) is dependant on the success of another process (e.g., Process B). Therefore the failure of Process B represents a risk to Process A. As such, the outsourcing, for example, of Process B only removes the risks directly associated with it, but cannot remove the network effect that it has on Process A. The exemplary methodology handles this by allowing the user to specify for Process A the risk of Process B failing.

The exemplary methodology captures correlation among different risks by correlation factors. The correlation factors are applied when performing LPD aggregation of the risks involved. The exemplary methodology is not exclusively reliant on the availability of quantitative data. The exemplary methodology provides management with the choice to use quantitative or qualitative data or a blend of both to develop LPDs. In this sense, the methodology is not completely reliant on historical operational loss data alone.

The exemplary methodology's data capture methodology can simplify management's task of characterizing the risk and control attributes for processes where there is little or no data. Processes which have a rich source of high quality data to characterize risk and control can be used to characterize similar processes for which there is little or no data. In one exemplary embodiment, an organization has already developed a robust business process view of the organization, where process definitions are standardized, mapped and well documented, such that a process hierarchy similar to the hierarchy 200 of FIG. 2 is already available or can be easily produced.

The hierarchy 200 represents the way business processes are actually managed and captures the network of process relationships within the organization i.e., how the various processes interact. From hierarchy 200, a chart 210 is derived which is the parent-child process hierarchy and is the basic structure defining how the various LPDs are aggregated. The relationship between the hierarchy 200 and chart 20 in FIG. 2 can be understood by examining the corresponding process notation.

In a second exemplary embodiment, a business process program is not in place. A process map hierarchy does not necessarily need to be created before the parent-child process hierarchy is created. Creating the parent-child process hierarchy is not a complex exercise because the complicated, time consuming process relationship detail is not required. Advantage can be gained by utilizing existing process information and any remaining gaps quickly obtained by requesting the input from various line managers and subject matter experts. It is possible to simply identify only the bottom level child processes perform LPD aggregations without the parent-child process hierarchy to place some predefined definitions to LPD aggregation. Under this scenario the information can still provide valuable management insights to operational risk adjusted productivity, operational risk and control behavior.

Those skilled in the art will appreciate that the invention described herein is susceptible to variations and modifications other than those specifically described. It should be understood that the invention includes all such variations and modifications which fall within the spirit and scope of the invention.

1. A device for facilitating a risk assessment, the device comprising a processor with programmed instructions for:
identifying a process associated with an organization, wherein the process is part of a process flow;
identifying a risk associated with the process; and
determining whether there exists empirical data about at least one loss event associated with the risk; and
processing the empirical data to obtain at least two distinct a loss probability distributions for the identified risk.

2. The device of claim 1, further comprising graphically presenting the process in a hierarchy of processes, wherein the hierarchy of processes represents an association between the process and a child and/or parent process.

3. The device of claim 1, wherein processing the empirical data comprises:
determining a first period Y of time for which the empirical data is relevant;
determining a second period y of time during the first period Yin which no risk event occurred;
determining a first probability P₁ of the risk occurring and a second probability P₀ of the risk not occurring, wherein P₀=y/Y and Pₗ=1−P₀;
determining a number of occurrences of the risk for each year Y-y in which the risk occurred;
sorting the number of occurrences in ascending order;
determining a low, a medium, and a high occurrence range; and
determining a probability of occurrence for the low occurrence range, the medium occurrence range, and the high occurrence range.

4. The device of claim 3, wherein processing the empirical data comprises:
determining a low L, a medium M, and a high H loss severity range;
determining a portion of losses that fall within the low, medium and high loss severity ranges; and
establishing a loss probability distribution.

5. The device of claim 1, wherein the at least two distinct loss probability distributions comprise:
a first distribution that represents a probability distribution of a loss event occurring when no control activities are used to manage the risk;
a second distribution that represents the probability distribution of the loss event occurring when an owner of the process uses a control activity to manage the risk; and
a third distribution that represents the probability distribution of the loss event occurring when a party independent of the process assesses the control.

6. A of device for facilitating a risk assessment, the device comprising a processor with programmed instructions for:
identifying a first process associated with an organization, wherein the process is part of a process flow;
identifying a first risk associated with the first process;
obtaining a first plurality of loss probability distributions assigned to the first risk; and
processing the first plurality of loss probability distributions to thereby create the information for use in facilitating the risk assessment.

7. The device of claim 6, further comprising graphically presenting the first process in a hierarchy of processes, wherein the hierarchy of processes is such that it represents an association between the first process and a child and/or parent process.

8. The device of claim 6, wherein the programmed instructions are further configured for:
identifying a second process associated with the first process;
identifying a second risk associated with the second process; and
obtaining a second plurality of loss probability distributions assigned to the second risk, wherein the operation of processing the first plurality of loss probability distribution comprises aggregating at least one of the first plurality of loss probability distributions and at least one of the second plurality of loss probability distributions to obtain at least one resultant loss probability distribution.

9. (canceled)

10. The device of claim 8, wherein the programmed instructions are further configured for:
obtaining a coefficient of correlation between one of the first plurality of loss probability distributions with at least one of another of the first plurality of loss probability distributions or at least one of another of the second plurality of loss probability distributions, wherein processing the first plurality of loss probability distributions comprises using the coefficient of correlation to obtain at least one resultant loss probability distribution.

11. The device of claim 6, wherein obtaining the first plurality of loss probability distributions comprises retrieving the first plurality of loss probability distribution from a plurality of loss probability distributions that comprises:
a first distribution that represents a probability distribution of a loss event occurring when no control activities are used to manage the first risk;
a second distribution that represents the probability distribution of the loss event occurring when an owner of the process uses a control activity to manage the first risk; and
a third distribution that represents the probability distribution of the loss event occurring when a party independent of the process assesses the control.

12. A device for facilitating a risk assessment, the device comprising a processor with programmed instructions to:
identify a process associated with an organization, wherein the process is part of a process flow;
identify at least one risk associated with the process; and
assign the risk at least two loss probability distributions to thereby create the information for use in facilitating the risk assessment.

13. The device of claim 12, wherein the programmed instructions are further configured to:
determine whether there exists empirical data about at least one loss event associated with the risk; and
process the empirical data to obtain the loss probability distribution.

14. The device of claim 12, wherein the loss probability distribution is one of a plurality of loss probability distributions assigned to the risk, wherein the loss probability distributions comprises:
a first distribution that represents a probability distribution of a loss event occurring when no control activities are used to manage the risk;
a second distribution that represents the probability distribution of the loss event occurring when an owner of the process uses a control activity to manage the risk; and
a third distribution that represents the probability distribution of the loss event occurring when a party independent of the process assesses the control.

15. (canceled)

16. The device of claim 12, wherein the programmed instructions are further configured to graphically present the process in a hierarchy of processes, wherein the hierarchy of processes is such that it represents an association between the process and a child and/or parent process.

17. The device of claim 13, wherein the programmed instructions are further configured to process the empirical data by:
determining a first period Y of time for which the empirical data is relevant;
determining a second period y of time during the first period Yin which no risk event occurred;
determining a first probability P₁ of the risk occurring and a second probability P₀ of the risk not occurring, wherein P₀=y/Y and P₁=1−P₀;
determining a number of occurrences of the risk for each year Y-y in which the risk occurred;
sorting the number of occurrences in ascending order;
determining a low, a medium, and a high occurrence range;
determining a probability of occurrence for the low occurrence range, the medium occurrence range, and the high occurrence range;
determining a low L, a medium M, and a high H loss severity range;
determining a portion of losses that fall within the low, medium and high loss severity ranges;
determining a worst case event T that can happen once every t years that recorded at least one occurrence; and
establishing a loss probability distribution.

18. A device for facilitating a risk assessment, the device comprising a processor having programmed instructions to:
identify a first process associated with an organization, wherein the process is part of a process flow;
identify a first risk associated with the first process;
obtain a first and second loss probability distribution assigned to the first risk; and
identify a second process associated with the first process;
identify a second risk associated with the second process; and
obtain a third and fourth loss probability distribution assigned to the second risk;
aggregate the first loss probability distribution and the third loss probability distribution to obtain a first resultant loss probability distribution.

19. (canceled)

20. The device of claim 18, wherein the programmed instructions are further configured to:
identify another risk associated with the process; and
obtain another loss probability distribution assigned to the another risk, wherein the step of processing the first loss probability distribution comprises aggregating the first loss probability distribution and the another loss probability distribution to obtain the resultant loss probability.

21. The device of claim 18, wherein the programmed instructions are further configured to obtain a coefficient of correlation between the first loss probability distribution and the second loss probability distribution, wherein processing the first loss probability distribution comprises using the coefficient of correlation to obtain a third resultant loss probability.

22. The device of claim 18, wherein the programmed instructions are further configured to graphically present an hierarchical representation of processes.

23. A computer program product comprising:
a module that receives information associated with a process of an organization, the information including a risk associated with the process;
a module that calculates a plurality of loss probability distributions for the risk;
a module that compares the plurality of loss probability distributions for the risk; and
instructions to graphically present the process in a hierarchy of processes, wherein the hierarchy of processes represents an association between the process and a child and/or parent process.

24. The device of claim 12 wherein one of the at least two loss probability distributions represents risk without controls and the other of the at least two loss probability distributions represents controlled risks.

25. The device of claim 12 wherein at least one of the at least two loss probability distributions is created from external data.

26. The device of claim 12 wherein at least two of the at least two loss probability distributions are compared with each other.

27. The device of claim 18, wherein the programmed instructions are further configured to aggregate the second loss probability distribution and the fourth loss probability distribution to obtain a second resultant loss probability distribution.

28. The device of claim 27, wherein the programmed instructions are further configured to compare the first resultant loss probability distribution to the second resultant loss probability distribution.

29. The device of claim 1, wherein the empirical data is from an external source.

30. The device of claim 18, wherein at least one of the first, second, third, or fourth loss probability distribution is created from external data.

31. The device of claim 6, wherein at least one of the first plurality of loss probability distributions is obtained from external data.

32. The device of claim 8, wherein at least one of the second plurality of loss probability distributions is obtained from external data.

33. The device of claim 1, further comprising comparing at least two of the at least two distinct loss probability distributions.

34. The device of claim 33, wherein the comparison is performed using a statistical moment.

35. The device of claim 34, wherein the statistical moment is one the following:
a mean; a variance; a skewness; a kurtosis; or a n^{th} moment about the mean.

36. The device of claim 34, wherein the comparison is performed using a derivative of the statistical moment.

37. The device of claim 36, wherein the derivative of the statistical moment is a standard deviation.

38. The device of claim 26, wherein the comparison is performed using a statistical moment.

39. The device of claim 28, wherein the comparison is performed using a statistical moment.

40. The device of claim 39, wherein the comparison is performed using a derivative of the statistical moment.

41. The device of claim 12 wherein processing includes comparing at least two of the first plurality of loss probability distributions.

42. The device of claim 41, wherein the comparison is performed using a statistical moment.

43. The device of claim 42, wherein the comparison is performed using a derivative of the statistical moment.

44. The device of claim 8, further comprising the operation of comparing the at least one resultant loss probability distribution to another loss probability distribution.

45. The device of claim 44, wherein the another loss probability distribution is a second resultant loss probability distribution obtained by aggregating at least one of the first plurality of loss probability distributions and at least one of the second plurality of loss probability distributions.

46. The device of claim 8, further comprising the operation of comparing at least one of the first plurality of loss probability distributions and at least one of the second plurality of loss probability distributions.

47. The device of claim 38, wherein the comparison is performed using a derivative of the statistical moment.

48. The device of claim 18, wherein the association is hierarchical.
